(19) United States
(12) Patent Application Publication
(10) Pub. No.: US 2013/0191178 A1
(43) Pub. Date: Jul. 25, 2013

(54) SYSTEM AND METHOD FOR SECURE REGISTRATION, AUTHENTICATION, VALUATION AND EXCHANGE OF VIRTUAL GOODS AND OBJECTS

(71) Applicant: PREDICTIVE EDGE TECHNOLOGIES, LLC, Blue Bell, PA (US)

(72) Inventors: William Michael Thompson, Lansdale, PA (US); Charles F. L. Davis, Lansdale, PA (US)

(73) Assignee: PREDICTIVE EDGE TECHNOLOGIES, LLC, Blue Bell, PA (US)

(21) Appl. No.: 13/746,729

(22) Filed: Jan. 22, 2013

Related U.S. Application Data
(60) Provisional application No. 61/590,522, filed on Jan. 25, 2012.

(51) Int. Cl. G06Q 30/02

(52) U.S. Cl. CPC G06Q 30/0201
USPC 705/7.29

(57) ABSTRACT

Systems and methods for management of virtual goods and objects including registration, authentication, market valuation and exchange thereof. Any virtual good or object may be registered via a Virtual Content Integration module which collects information about the virtual good or object from the creator thereof which, when complete, is transmitted to a Virtual Content Authentication module, where ownership information is embedded within the virtual good or object as meta data and/or cross referenced by the metadata within an authentication registry. All transactions involving the virtual good or object are transmitted through and referenced by a Virtual Content Transaction module. All transactions managed by the system and method are evaluated by a Virtual Content Exchange module which determines the real world equilibrium price of the virtual good or object based on estimated supply and demand curves to establish the parameters for and provide a commodity exchange for virtual goods and objects.

### CROSS REFERENCE TO RELATED APPLICATION(S)

This application claims the benefit of U.S. Provisional Application No. 61/590,522, filed Jan. 25, 2012, the disclosure of which is incorporated in its entirety by reference thereto.

### FIELD OF THE INVENTION

The present invention relates in general to computer software and management of computer generated virtual objects and, in particular, to management of registration, authentication, transfer, exchange, and market value determination of virtual goods and objects.

### BACKGROUND OF THE INVENTION

A virtual world or environment is an online community that is a computer-generated digital representation and simulation of an environment through which users can interact with one another and create and use virtual goods or objects. Users assume virtual forms known as avatars which may appear as textual or two-dimensional or three-dimensional graphical representations.

In a virtual world, a computer accesses a computer-simulated world or environment and presents perceptual stimuli to the user who, in turn, can manipulate elements of the modeled world and thus experience a degree of telepresence. Such modeled worlds and their rules may draw from the reality or fantasy worlds. Exemplary rules include, without limitation, gravity, topography, locomotion, real-time actions, and communication. Communication between users can range from and include text, graphical icons, visual gesture, and sound.

Virtual worlds or environments vary in sophistication from highly sophisticated spatial environments like those seen in the games Second Life®, The Sims®, and Star Wars The Old Republic® to environments that simply project a player's avatar to other members of the online community such as is experienced on XBox Live®.

A virtual economy is the emergent property resulting from interactions between participants in a virtual world or environment. Though the developers of virtual worlds and environments have a great deal of control over the economy by the encoded mechanics of trade, it is nonetheless the actions of users that define the economic conditions of a virtual world or environment. The economy arises as a result of the choices that users make responsive to the scarcity of real and virtual resources such as time or currency. Participants have a limited time in the virtual world, as in the real world, during which they must divide their attention between tasks such as collecting resources, practicing trade skills, or engaging in less productive fun or play. The choices they make in their interactions with the virtual world, along with the mechanics of trade and wealth acquisition, dictate the relative values of items in the virtual economy. The economy in virtual worlds is typically driven by in-game needs such as equipment, food, or trade goods. Virtual economies like that of Second Life®, however, are almost entirely player-produced with very little link to in-game needs.

The value of objects in a virtual economy is usually linked to their usefulness and the difficulty of obtaining them. The investment of real world resources (time, membership fees, etc.) in acquisition of wealth in a virtual economy may contribute to the real world value of virtual content. This real world value is manifested by the trade of virtual items on online market sites like eBay®. Recent legal disputes also give credence to the real-world value of virtual property, even overriding end user license agreements (EULAs) which many software companies use to assert that virtual property has no value and/or that users of the virtual world have no legal claims to property therein.

The perceived real world or physical value of virtual objects and goods has steadily increased with the introduction of licensed and branded virtual world objects and the promotion of rare “limited edition” items that can be purchased with real world currency.

### SUMMARY OF THE INVENTION

The present invention provides for centralized registration, authentication, market valuation, and exchange of virtual goods and objects (VGOs). VGOs are non-physical items or representative concepts that are purchased for use in online communities and games. These items have no intrinsic value and by definition are intangible. They may include, without limitation, digital clothing for computer-based avatars, or other items of interest to the controller of an avatar. Additionally, the present invention recognizes avatars themselves as VGOs that could be valued and traded subject to the system and method presented herein. The system and method according to the invention utilizes several modules with specific utility to effectively manage, protect, and syndicate the perceived value of VGOs.

There is provided means for embedding a certificate of registration of ownership characteristics into a VGO, as well as means for authenticating the VGO. The system and method may also be used for the establishment and determination of real world market value for VGOs through the monitoring of value fluctuations of the VGOs based on availability, demand, and historical market conditions as they exist within the virtual world or environment.

In an embodiment of the invention, there is provided a system and method for the registration of VGOs, assignment of ownership, and the immutable establishment of authenticity. The system and method also provides for the transfer of VGOs as well as the establishment of a central exchange to trade VGOs based on market conditions and considerations across all virtual worlds and environments where the VGOs can be deployed or are currently used. The system is desirably comprised of the following:

a computer-implemented VGO Content Integration Module for preparing newly-created VGO content for management by the system, where registration information such as owner, initial value, and other identifying characteristics are written to a VGO Content Certification Registry and Repository (registration) database;

a computer-implemented Virtual Content Authentication Module, which module functions as a means of third party verification by integrating the registration database containing registrations performed by the Content Integration Module and, if supported by the VGOs' destinations, embedding registration details into VGOs to establish authenticity through steganography or other means of immutable watermarking;

a computer-implemented Virtual Content Transaction Module which allows for recordation in a connected VGO Commerce database all transactions including, for example: transfers, sales, modifications, retirement, or destruction of virtual property registered by the invention; and

a computer-implemented Virtual Content Exchange Module where data is integrated from both the VGO Commerce database and a Historical VGO Market Activity database to provide dynamic real world market data as to the elasticity of both supply and demand of any VGOs managed by the invention. Additionally, the Virtual Content Exchange Module establishes transaction parameters and provides the platform for the VGO to be traded as a real world commodity.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a system diagram of an exemplary embodiment of the present invention; and

FIG. 2 illustrates a flow diagram that depicts the progression of a virtual good or object through a system constructed and arranged according to the present invention.

### DETAILED DESCRIPTION OF THE INVENTION

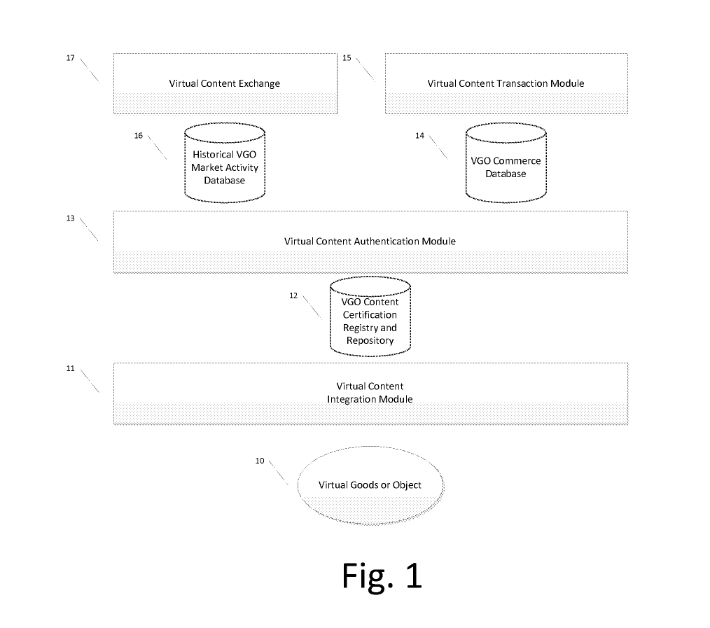

Referring to the drawings there is shown in FIG. 1 a system diagram of one embodiment of the present invention. The diagram follows a “bottom to top” enumeration.

As is known, a virtual good or object (VGO) has no physical properties and exists as a digital construct or file. As seen in FIG. 1, a collection of such VGOs are identified by reference numeral 10. According to the invention, the registration of VGOs is managed by a Virtual Content Integration Module 11 via which an originator or creator of a VGO interacts to provide specific information about the VGO, such as creation date, creation time, author, estimated per-unit value, etc., in order to establish provenance for the VGO. Upon receipt of VGO identification information from the creator of the VGO, the Virtual Content Integration Module 11 generates meta tags for inclusion within the digital file of the VGO if the file format native to the VGO supports such a feature. Module 11 also replicates the meta tag entry for a VGO in a database of meta data from previous generations, i.e., a VGO Content Certification Registry and Repository, which is identified by reference numeral 12.

Information regarding a VGO previously registered by the Virtual Content Integration Module 11 and stored within the VGO Content Certification Registry and Repository 12 is then accessed by a Virtual Content Authentication Module 13. Based on information provided by the creator or owner of the VGO at the time of introduction into the system via the Virtual Content Integration Module 11, authentication entries are transmitted back to the VGO Content Certification Registry and Repository 12 where the initial VGO entries are updated to reflect the level and depth of authentication within and appropriate for the VGO.

If the VGO supports direct integration of authentication, then the Virtual Content Authentication Module 13 can embed the registration meta tag data from the VGO Content Certification Registry and Repository 12 directly into a VGO's file. In this regard, the present system contemplates several means of integration. However, a preferred approach is the use of steganography, whereby a binary image file used to represent the VGO is digitally altered in a manner that is imperceptible to the observer, but when decoded by the Virtual Content Authentication Module 13 recreates the registration token originally stored within the VGO Content Certification Registry and Repository 12.

All transactions involving the VGO are then processed by a Virtual Content Transaction Module 15, the results of which are stored in a VGO Commerce Database 14 for the purpose of providing historical provenance. Finally, all transactions managed by the system and method according to the invention are evaluated by a Virtual Content Exchange Module 17 which determines the equilibrium price of the VGO based on estimated supply and demand curves in the virtual world to establish the parameters for and provide a real world commodity exchange for VGOs. The results of the analyses performed by the Virtual Content Exchange Module 17 are stored in a Historical VGO Market Activity Database 16 to provide a historical record of virtual and real word demand and market conditions.

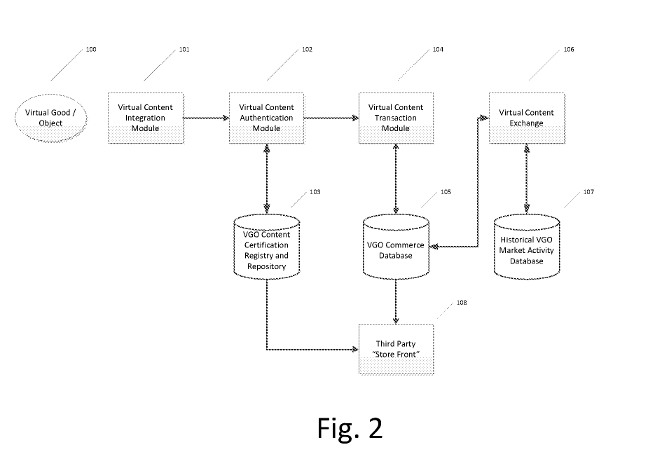

FIG. 2 represents an exemplary embodiment of a system according to the invention, which diagram is represented as a process flowchart and is enumerated as such. At 100, the VGO has no physical properties and exists as a digital construct or file. Registration of the VGO is managed by the Virtual Content Integration Module 101 in which an originator or creator of the VGO provides specific information about the VGO such as creation date, time, author, estimated per-unit value, etc., to establish provenance of the VGO. Presented with such provenance information, the Virtual Content Authentication Module 102 generates meta tags for inclusion within the digital file, which may or may not be readily noticeable in the presentation of the digital content, in addition to replicating the meta tag entry in a database, namely, the VGO Content Certification and Registry Repository 103 that includes registrations from previous generations and/or iterations of the VGO.

The virtual provenance record is then provided to third party virtual storefronts 108 that sell VGOs according to the established provenance and authenticity and real world value of the VGOs as determined by the Virtual Content Exchange Module. All transactions regarding the virtual good or object are recorded by the Virtual Content Transaction Module 104 and a historical record is maintained by the VGO Commerce Database 105. Information specific to the real world dynamic market value, as opposed to the perceived real world value of the VGO at the time of entry into the system is determined by a Virtual Content Exchange Module 106 that compares current commerce activity maintained in the VGO Commerce Database 105 to historical market performance and activity of the VGO or class of VGO maintained in the Historical VGO Market Activity Database 107.

The insertion or embedding of immutable provenance data into a VGO is unique and novel and has not been contemplated in the prior art.

It will be understood that all modules described herein may be manifested in centralized or decentralized/distributed hardware, software, or any combination thereof. Likewise, any and all of the previously described databases may be in the form of a single database or a plurality of distributed databases as may be desired or necessary to achieved the objects set forth herein. Further, as in any computer-implemented system, the invention may be controlled by any of one or more suitably cooperating central processing units or microprocessors operable to execute the logic, rules and/or programming established by the several modules described herein.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A system for managing virtual good or object (VGO) files, said system comprising:
a VGO Content Certification Registry and Repository database operable to store VGO registration information;
a computer-implemented VGO Content Integration Module for preparing newly-created VGO content and for storing VGO registration information in said VGO Content Certification Registry and Repository database;
a computer-implemented Virtual Content Authentication Module for integrating said VGO Content Certification Registry and Repository database and for embedding registration meta tags into VGO files to establish authenticity of the VGO files;
a VGO Commerce database operable to store registered VGO transactions;
a computer-implemented Virtual Content Transaction Module for storing registered VGO transactions in said VGO Commerce database;
a Historical VGO Market Activity database operable to store historical VGO market performance and activity; and
a computer-implemented Virtual Content Exchange Module for integrating data from both said VGO Commerce database and said Historical VGO Market Activity database to provide dynamic real world market data as to the elasticity of both supply and demand for VGOs.

2. The system of claim 1 wherein said VGO registration information includes at least one of owner, creation date, creation time, author, and estimated per-unit value.

3. The system of claim 1 wherein said embedding registration details comprises embedding through immutable watermarking.

4. The system of claim 3 wherein said immutable watermarking comprises steganography.

5. The system of claim 1 wherein said registered transactions comprise at least one of transfers, sales, modifications, retirement, or destruction of registered VGOs.

6. The system of claim 1 wherein said Virtual Content Exchange Module establishes transaction parameters and provides a platform for the VGO to be traded as a real world commodity.

7. A method for managing virtual good or object (VGO) files, said method comprising the steps of:
using a computer-implemented VGO Content Integration Module to prepare newly-created VGO content and to store VGO registration information in a VGO Content Certification Registry and Repository database;
using a computer-implemented Virtual Content Authentication Module to integrate the VGO Content Certification Registry and Repository database and to embed registration meta tags into VGO files to establish authenticity of the VGO files;
using a computer-implemented Virtual Content Transaction Module to store registered VGO transactions in a VGO Commerce database; and
using a computer-implemented Virtual Content Exchange Module to integrate data from both the VGO Commerce database and a Historical VGO Market Activity database to provide dynamic real world market data as to the elasticity of both supply and demand for VGOs.

8. The method of claim 7 wherein VGO registration information includes at least one of owner, creation date, creation time, author, and estimated per-unit value.

9. The method of claim 7 wherein embedding registration details comprises embedding through immutable watermarking.

10. The method of claim 9 wherein the immutable watermarking comprises steganography.

11. The method of claim 7 wherein said registered transactions comprise at least one of transfers, sales, modifications, retirement, or destruction of registered VGOs.

12. The method of claim 7 wherein the Virtual Content Exchange Module establishes transaction parameters and provides a platform for the VGO to be traded as a real world commodity.
